(19) United States
(12) Patent Application Publication
(10) Pub. No.: US 2006/0059566 A1
(43) Pub. Date: Mar. 16, 2006

(54) System and method for using a graphic and/or audio license with digital rights management systems

(75) Inventor: Timo Rastas, Helsinki (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/940,332

(22) Filed: Sep. 14, 2004

(51) Int. Cl. H04L 9/32; H04N 7/16; G06F 17/30; G06F 7/04; G06K 9/00; H03M 1/68; H04K 1/00; H04L 9/00

(52) U.S. Cl. 726/27; 726/28; 726/29; 726/30

(57) ABSTRACT

A system and method for using an audio and/or graphic license with a digital rights management system. Content is downloaded with an OMA forward-lock wrapper and rendered for an individual device. Licensed graphics and/or sound files are stored in respective graphics and/or audio file subdirectories. Upon the launching of a specific application, the availability of a specific graphic or sound file is checked. The specific graphic or sound file is used as a splash screen or a splash sound. At the same time, metadata stored in the respective sound or graphics files can include code for checking information such as whether the license has expired.

### FIELD OF THE INVENTION

The present invention relates to digital rights management and device management. More particularly, the present invention relates to license keys for digital rights management.

### BACKGROUND OF THE INVENTION

Digital Rights Management (“DRM”) is a term used to describe a range of techniques that use information about rights and rights holders to manage copyright material and the terms and conditions on which the material is made available to users. More specifically, DRM involves the description, layering, analysis, valuation, trading, and monitoring of an owner's property rights to an asset.

DRM covers the management of the digital rights to the physical manifestation of a work (e.g., a textbook) or the digital manifestation of a work (e.g., an Internet web page). DRM also covers the management of an asset whether the asset has a tangible or an intangible value. Current DRM technologies include languages for describing the terms and conditions for an asset, tracking asset usage by enforcing controlled environments or encoded asset manifestations, and closed architectures for the overall management of the digital rights.

In general, DRM protection is based on the principle that every end-entity capable of consuming DRM protected content is equipped with a cryptographic key, which usually is unique for every end-entity. DRM-protected content is distributed, possibly together with a set of consumption rights, in encrypted form. Thus, only authorized parties, usually those that have paid for the content, are able to consume the content. This is done, for example, by encrypting the content with the public key matching the recipient's private DRM key (asymmetric key encryption). For practical reasons, usually a hybrid scheme is chosen, wherein DRM protected content is encrypted under a content encryption key (CEK) using symmetric encryption. The CEK in turn is then encrypted with the public DRM key matching the recipient's private DRM key. The CEK may be accompanied by consumption rights (which may also be encrypted) expressing the usage rules for the DRM protected content.

The effect is the same for both approaches, i.e., only authorized parties are able to consume the DRM protected content (if implemented securely and correctly). The two approaches, however, also share a drawback originating from the fact that every end-entity is equipped with a unique DRM key: content (or the CEK) has to be personalized for every device prior to consumption.

Usually, DRM content is protected (using encryption, for example) by the network side for various reasons, e.g., to guarantee payment for the content. Typically, the network infrastructure has a server for personalizing content transported in the wireless network. The network-centric nature of current approaches, however, is not very suitable for certain types of content, e.g., free content. One example is content intended for preview purposes.

It is usually the case that the transfer of purchased DRM-protected content from one terminal to another cannot be performed by the end user of a terminal. Typically, the rights holders for the content want to enforce certain usage rights over content management, and this includes in most cases control over how content can be copied and which technical and security requirements have to be met.

Challenges in the context of DRM include handling the license data (e.g., distributing it to the user, checking it, managing it on the terminal), using the license data in a meaningful way, and preventing the unauthorized use of the application to be protected (e.g., copying or circumventing the rights checking). Conventional attempts at resolving these challenges do not tie the functioning of the software application to the license. Instead, only a simple check for a license is performed. Such simple checks are easily removed or manipulated.

Thus, there is a need to manage licensed software applications in a digital rights management (DRM) environment. Further, there is a need to combine copy protection mechanisms with rights management for software applications. Even further, there is a need for improved techniques for licensing, using, and preventing unauthorized use of data protected using DRM.

### SUMMARY OF THE INVENTION

The present invention is directed to the use of Open Mobile Alliance (OMA) forward-lock protected content as a license key for an application. Application licenses are distributed to OMA forward-lock enabled terminals as content. License-related graphics and/or sound files are stored in the appropriate subdirectories and include metadata therein that can be used for check information such as whether a respective license has expired.

The present invention provides a number of distinct advantages over prior art systems. License files that include graphic and/or sound files no longer simply take up space in a device's memory without serving another function which can be helpful to a user. The present invention also allows the super-distribution with OMA forward-lock enabled device, and is also less expensive to distribute for the service provider. With the present invention, the user is also capable of actually seeing the licenses that exists in the designated subdirectories on the device. Licenses can be backed up with other content, and OMA forward-locked content is still not usable on other devices if copied.

The present invention makes it easier for an end user to obtain a license than it is using conventional systems, where a code is based upon the device's particular International Mobile Equipment Identity (IMEI). The present invention is also less expensive for the service provider than conventional systems where the service provider must handle specific consumer requests. Instead, the service provider only needs to sell content keys. The present invention is also preferable over the installation of an additional piece of software (such as a dynamic link library) because the location of personalized graphics and/or sounds is standardized and a browser is capable of handling the installation process with a specific installer.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Exemplary embodiments will hereafter be described with reference to the accompanying drawings.

FIG. 1 is a diagram showing a transfer module which performs the secure transfer of digital rights management (DRM) user data from one terminal to another in accordance with an exemplary embodiment.

FIG. 2 is a diagram illustrating functional components in a digital rights management license manager system;

FIG. 3 is a perspective view of a mobile telephone that can be used in the implementation of the present invention;

FIG. 4 is a schematic representation of the telephone circuitry of the mobile telephone of FIG. 3; and

FIG. 5 is a flow chart showing the installation and use of a graphic and/or audio license according to one embodiment of the present invention.

### DETAILED DESCRIPTION OF THE PREFERRED EMBODIMENTS

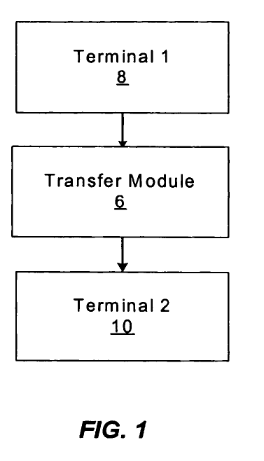

FIG. 1 illustrates a transfer module 6 which enables the secure transfer of digital rights management (DRM) user data from a first terminal 8 to a second terminal 10. The transfer module 6 handles content files or license files from the first terminal 8. The transfer module 6 is preferably a software module provided to the second terminal 10 from a communication service provider. The transfer module 6 facilitates the transfer of DRM user data by decrypting and re-encrypting content and license files. In an exemplary embodiment, the first and second terminals 8 and 10 are mobile telephones and the communication service provider is an organization such as the Nokia Customer Care Organization operated by Nokia Corporation of Finland. It should be understood, however, that the present invention is not intended to be limited to one particular type of mobile telephone or other electronic device.

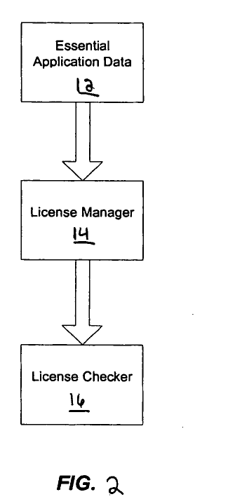

FIG. 2 illustrates functional components in a digital rights management (DRM) license manager system. In an exemplary embodiment, the DRM license manager system includes essential application data 12, a license manager 14, and a license checker 16. The essential application data 12 is any data needed by a particular application for proper operation. The license manager 14 processes a software application package using the essential application data 12.

The software application package may or may not have an associated software license available on the terminal or system on which the software application is loaded. The license checker 16 determines if the correct license is present in the terminal or system. If the software license is available, the software application can be executed. Otherwise, the software application cannot be executed.

In DRM systems, the valuable content is distributed in such a manner that the content can only be used in the device where it was originally downloaded. This is often accomplished by using a license that is somehow bound to that particular device. One approach to achieve this objective is to use a specific data, such as the IMEI code of the device. Using the IMEI code or similar data guarantees that the content can only be used on that particular device.

In accordance with the principles of the present invention, application licenses are distributed to OMA forward-lock terminals as content. “Forward-lock” refers to the ability to block certain content by marking content copyrighted. Thus, instead of requiring the use of block-lists that ban for example, files with certain formats, with forward-lock, content providers are able to state that the picture bought from a site is copyrighted content, and that the file cannot be transferred from the original downloaded device to another device.

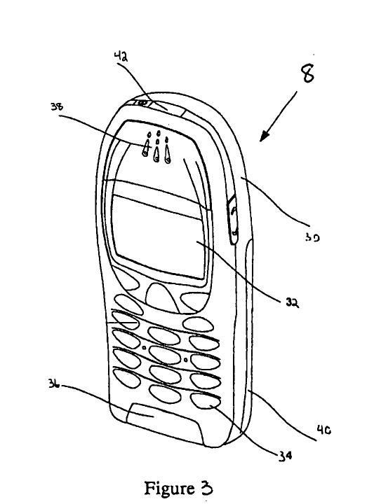

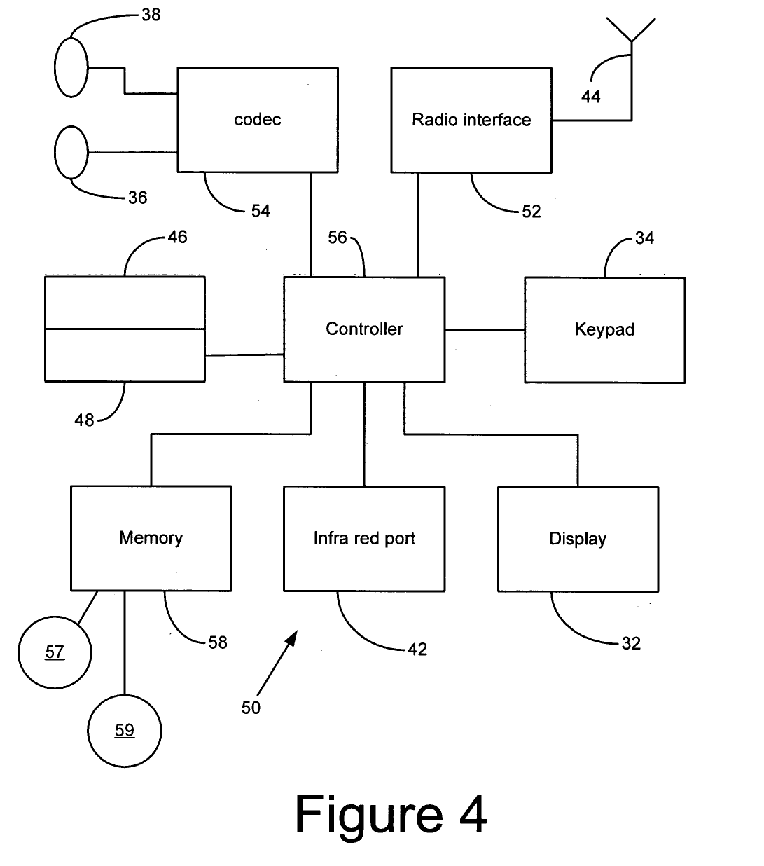

FIGS. 3 and 4 are representations of a generic first terminal 8 upon which the present invention may be implemented. The second terminal 10 may take generally the same form. The mobile telephone 8 of FIGS. 3 and 4 includes a housing 30, a display 32 in the form of a liquid crystal display, a keypad 34, a microphone 36, an ear-piece 38, a battery 40, a communication link 42 (for example, in the form of an infrared port), an antenna 44, a smart card 46 in the form of a universal integrated circuit card (UICC) according to one embodiment of the invention, a card reader 48, and mobile telephone circuitry 50. The mobile telephone circuitry 50 includes remote interface circuitry 52, codec circuitry 54, a controller or processor 56 and a memory 58. The memory 58 includes a variety of directories, including at least one graphics file subdirectory 57 and at least one audio file subdirectory 59. Individual circuits and elements are all of a type well known in the art, for example in the Nokia range of mobile telephones.

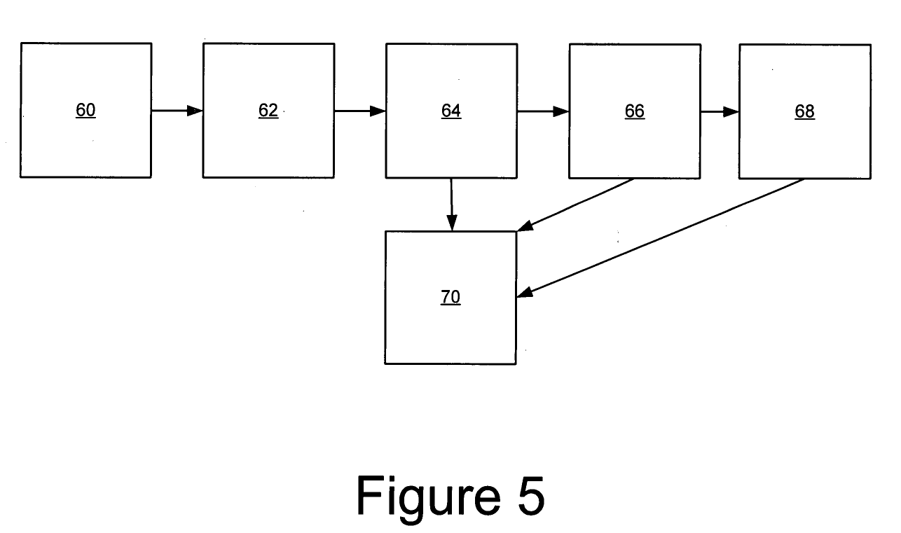

FIG. 5 shows a process for implementing the present invention. According to the present invention, at step 60 content is downloaded with an OMA forward-lock wrapper and rendered for the individual device, such as a particular mobile phone. At step 62, licensed graphics and/or sound files are stored in the respective graphics file subdirectories 57 and audio file subdirectories 59 that are used to store graphics and/or sound files. Upon the launching of a specific application at step 64, the availability of a specific graphic or sound file is checked at 66. The specific graphic or sound file is used as a splash screen or a splash sound at step 68. A splash screen is a screen that is viewed by a user before the main content is accessed. A splash sound is similar to a splash screen, except a sound is played before the main content is accessed. The splash screen can take the form of a wallpaper to be exhibited on the display or a .jpg or .bmp file to be exhibited on the display. The splash sound can take the form of a .midi file, a ring tone for a mobile phone, or virtually any other type of sound that can be played.

At the same time, metadata stored in the respective sound or graphics files can include code for checking information such as whether the license has expired, or whether there are any other types of constraints on the use of the copyrighted material. These processes are cumulatively shown at step 70 and can occur at a variety of times. In this way, the OMA forward-lock protected content can serve as the license key to an application.

While several embodiments have been shown and described herein, it should be understood that changes and modifications can be made to the invention without departing from the invention in its broader aspects. For example, but without limitation, the present invention can be used in conjunction with a variety of electronic devices. Various features of the invention are defined in the following Claims.

What is claimed is:

1. A device having a licensed software application subject to digital rights management limitations, the device comprising:
a processor; and
a memory unit operatively connected to the processor, the memory unit including a data file providing information to a user as well as limiting the use of the data file subject to digital rights management limitations.

2. The device of claim 1, wherein the data file comprises a graphics file.

3. The device of claim 2, wherein the graphics file includes a graphic for display as a splash screen on the device.

4. The device of claim 1, wherein the data file comprises an audio file.

5. The device of claim 4, wherein the audio file includes a sound to be played as a splash sound on the device.

6. The device of claim 1, wherein the data file includes code for determining whether a digital rights management license has expired.

7. A method for subjecting a licensed software application to digital rights management limitations on a device, comprising the steps of:
downloading content with an OMA forward-lock wrapper on a device;
storing a data file from the content in a designated location;
upon launching an application, providing information from the data file to a user; and
using metadata stored in the data file to limit the use of the data file subject to digital rights management limitations.

8. The method of claim 7, wherein the data file is a graphics file.

9. The method of claim 8, wherein the graphics file includes a graphic for display as a splash screen on the device.

10. The method of claim 7, wherein the data file comprises an audio file.

11. The method of claim 10, wherein the audio file includes a sound to be played as a splash sound on the device.

12. The method of claim 7, wherein the data file includes code for determining whether a digital rights management license has expired.

13. A computer program product for subjecting a licensed software application to digital rights management limitations on a device, comprising the steps of:
computer code for downloading content with an OMA forward-lock wrapper on a device;
computer code for storing a data file from the content in a designated location;
computer code for upon launching an application, providing information from the data file to a user; and
computer code for using metadata stored in the data file to limit the use of the data file subject to digital rights management limitations.

14. The computer program product of claim 13, wherein the data file is a graphics file.

15. The computer program product of claim 14, wherein the graphics file includes a graphic for display as a splash screen on the device.

16. The computer program product of claim 13, wherein the data file comprises an audio file.

17. The computer program product of claim 16, wherein the audio file includes a sound to be played as a splash sound on the device.

18. The computer program product of claim 13, wherein the data file includes code for determining whether a digital rights management license has expired.

19. A module for use with an electronic device, comprising:
a processor; and
a memory unit operatively connected to the processor, the memory unit including a data file providing information to a user as well as limiting the use of the data file subject to digital rights management limitations.

20. The module of claim 19, wherein the data file comprises a graphics file.

21. The module of claim 20, wherein the graphics file includes a graphic for display as a splash screen on the electronic device.

22. The module of claim 19, wherein the data file comprises an audio file.

23. The module of claim 22, wherein the audio file includes a sound to be played as a splash sound on the electronic device.

24. The module of claim 19, wherein the data file includes code for determining whether a digital rights management license has expired.
